(19) United States
(12) Patent Application Publication
(10) Pub. No.: US 2020/0366800 A1
(43) Pub. Date: Nov. 19, 2020

(54) APPARATUS

(71) Applicant: KONICA MINOLTA, INC., Tokyo (JP)

(72) Inventor: Daiki NISHIOKA, Tokyo (JP)

(73) Assignee: KONICA MINOLTA, INC., Tokyo (JP)

(21) Appl. No.: 16/840,594

(22) Filed: Apr. 6, 2020

(30) Foreign Application Priority Data
May 16, 2019 (JP) 2019-093224

(51) Int. Cl. H04N 1/00; G10L 15/22

(52) U.S. Cl. CPC H04N 1/00403; H04N 1/00395; G10L 15/22

(57) ABSTRACT

An apparatus receives an instruction from a user by speech by dialogic interaction, and includes: a hardware processor that: determines an experience value of the user regarding use of the apparatus; and modifies an information amount to be provided to the user by speech in the dialogic interaction depending on the user's experience value determined by the hardware processor.

The entire disclosure of Japanese patent Application No. 2019-093224, filed on May 16, 2019, is incorporated herein by reference in its entirety.

### BACKGROUND

### Technological Field

The present invention relates to an apparatus that receives instruction operation from a user by speech by dialogic interaction.

### Description of the Related Art

In the related art, operability of apparatuses are enhanced using speech guidance. However, it takes more time to play speech guidance than to display on a screen, and thus playing the same speech guidance at all times impairs convenience for experienced users.

In response to this disadvantage, JP 2018-147321 A discloses an apparatus that measures time that a user has spent for input operation from an operation screen and controls not to play speech guidance in a case where the input operation time does not exceed a certain value, by determining the user as an experienced user.

Meanwhile, in recent years, the accuracy of speech recognition has been remarkably improved by the use of artificial intelligence technology, and there are increasing number of apparatuses that have a speech operation function of inputting various instructions from a user by speech. In speech operation, a dialogic user interface is usually provided in which the apparatus plays speech guidance, and a user who hears the speech guidance inputs a next instruction by speech.

In dialogic speech operation, the time required for input is longer than that of a user interface that uses an operation screen and operation buttons.

The technology of JP 2018-147321 A, which controls whether to play speech guidance depending on whether a user is experienced, is useful for apparatuses that accept input operation from a user on an operation screen and utilizes speech guidance merely as an auxiliary means. In apparatuses that mainly use speech-based dialogic user interface, however, if it is controlled not to play speech guidance at all, there is a disadvantage that even an experienced user cannot understand next operation and the speech operation cannot be continued.

### SUMMARY

The present invention is intended to solve the above-described disadvantage, and an object of the present invention is to provide an apparatus capable of providing a user-friendly speech operation to any user having varying experience values for using the apparatus.

To achieve the abovementioned object, according to an aspect of the present invention, there is provided an apparatus that receives an instruction from a user by speech by dialogic interaction, and the apparatus reflecting one aspect of the present invention comprises: a hardware processor that: determines an experience value of the user regarding use of the apparatus; and modifies an information amount to be provided to the user by speech in the dialogic interaction depending on the user's experience value determined by the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a configuration example of an apparatus according to an embodiment of the present invention;

FIG. 2 is a diagram illustrating an apparatus configuration in a case where a camera and a user confirmation server are coupled to the apparatus illustrated in FIG. 1;

FIG. 3 is a block diagram illustrating a schematic configuration of the apparatus body of the apparatus illustrated in FIG. 2;

FIG. 4 is a diagram illustrating another configuration example of the apparatus according to an embodiment of the present invention;

FIG. 5 is a block diagram illustrating a schematic configuration of the apparatus illustrated in FIG. 4;

FIG. 6 is a flowchart illustrating processes performed by a speech recognition server;

FIG. 7 is a flowchart of processes performed by the user confirmation server;

FIG. 8 is a flowchart illustrating processes performed by the apparatus body regarding speech operation;

FIG. 9 is a table illustrating an example of a determination table;

FIG. 10 is a sequence diagram illustrating an example of speech operation for experience value level 6;

FIG. 11 is a diagram illustrating an example of interaction by speech operation for experience value levels 1 to 4;

FIG. 12 is a diagram illustrating an example of interaction by speech operation for experience value level 5;

FIG. 13 is a diagram illustrating an example of interaction by speech operation for experience value level 6; and

FIG. 14 is a diagram illustrating an example of interaction by speech operation for experience value level 7.

### DETAILED DESCRIPTION OF EMBODIMENTS

Hereinafter, one or more embodiments of the present invention will be described with reference to the drawings. However, the scope of the invention is not limited to the disclosed embodiments.

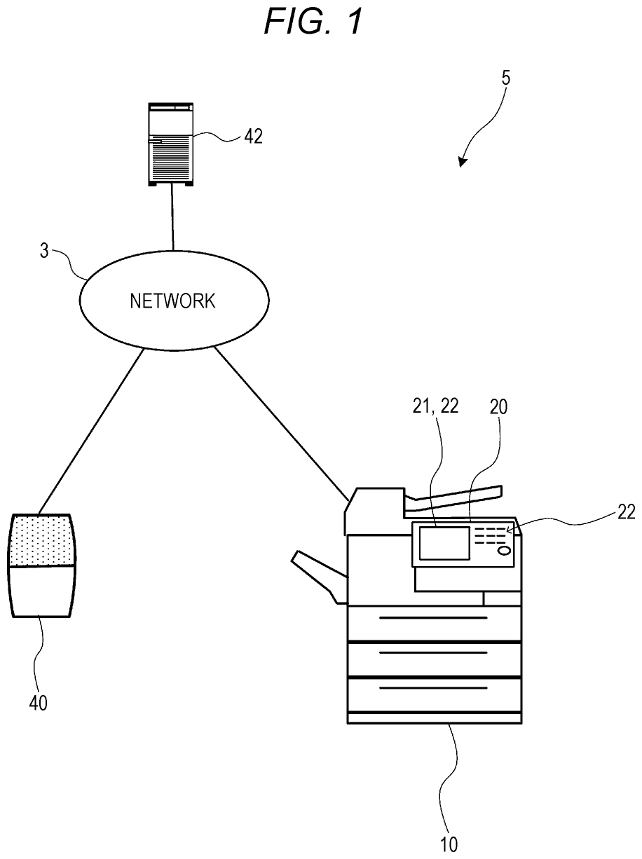

FIG. 1 is a diagram illustrating a configuration example of an apparatus 5 according to an embodiment of the present invention. The apparatus 5 includes a speech input/output terminal 40, a speech recognition server 42, and an apparatus body 10 that are communicably coupled with each other. Here, the speech input/output terminal 40 and the speech recognition server 42 are coupled via a network, and the speech recognition server 42 and the apparatus body 10 are coupled via the network. The speech input/output terminal 40 and the speech recognition server 42 serve as a user interface that controls speech input/output.

The apparatus body 10 may be any apparatus. Here, a so-called multifunction peripheral (MFP) is assumed which has functions such as a copy function of optically reading an original and printing a duplicate image on recording paper, a scan function of saving image data of a read original as a file or sending the image data to an external terminal via a network, a printer function of printing and outputting, on recording paper, an image relating to print data received through a network from a personal computer (PC) or the like, and a facsimile function of sending and receiving image data in accordance with a facsimile procedure.

The speech input/output terminal 40 includes a microphone (Microphone) that converts speech uttered by a user into electric signals, a speaker that outputs sound (physical vibration) that corresponds to speech data, a speech input/output circuit, and a communicator that communicates with the speech recognition server 42. The speech input/output terminal 40 has a function of transmitting speech data that corresponds to speech signals output from the microphone to the speech recognition server 42 and a function of outputting sound that corresponds to speech data received from the speech recognition server 42 from the speaker.

The speech recognition server 42 has functions such as a function of analyzing speech data received from the speech input/output terminal 40, converting speech into a text and transmitting the text to the apparatus body 10, and a function of converting text data received from the apparatus body 10 into speech data and transferring the speech data to the speech input/output terminal 40.

The apparatus body 10 receives various types of setting operation from a user by operation on hardware switches on an operation panel or software switches displayed on the screen, and further has a speech operation function of receiving various inquiries, requests, instructions, settings, and the like by speech by dialogic interaction. When receiving an instruction such as a job input by speech operation, the apparatus body 10 displays an operation screen that corresponds to the instruction on the operation panel. The user can confirm settings of the job set by the speech operation on the operation screen.

Input/output of speech by speech operation is performed using the speech input/output terminal 40.

The apparatus body 10 determines the experience value of a user who is performing the speech operation regarding the use of the apparatus when receiving the speech operation, and modifies the information amount (such as how much detailed the speech guidance is, how much detailed the steps are) provided to the user by speech in dialogic interaction depending on the experience value of the user. That is, the higher the experience value of the user is, the less the information amount provided to the user by speech becomes (such as simplifying the speech guidance or omitting steps of interaction). Moreover, the utterance speed is modified depending on the experience value of the user. For example, when the user's experience value is lower than a certain level, the utterance speed is lowered than usual.

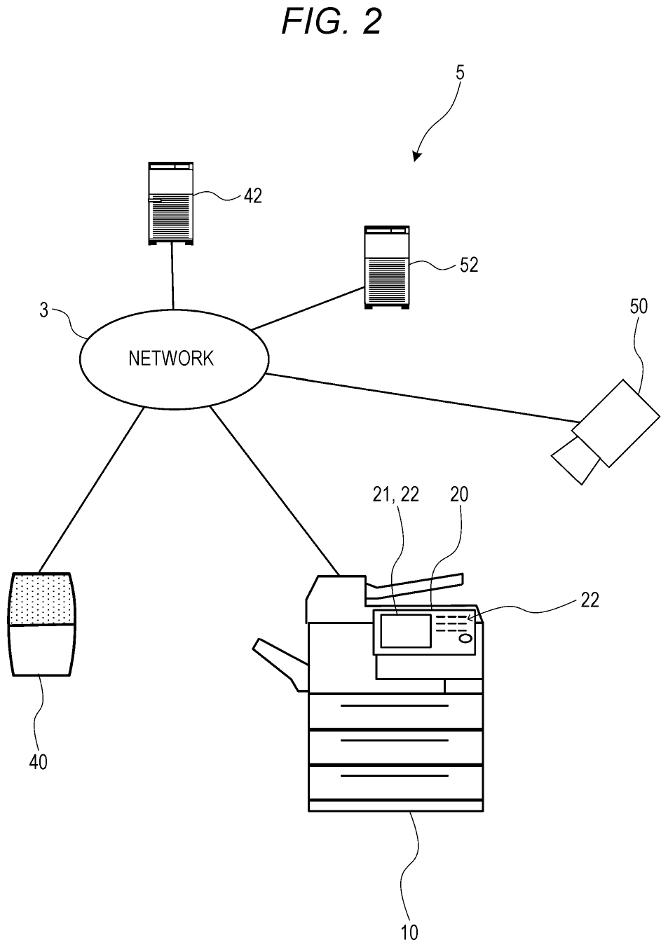

FIG. 2 illustrates a configuration example of the apparatus 5 illustrated in FIG. 1, further including a camera 50 that shoots a moving image covering the apparatus body 10 and a predetermined area and around the apparatus body 10 and a user confirmation server 52. The camera 50 is coupled to the user confirmation server 52 via the network, and the user confirmation server 52 and the apparatus body 10 are coupled via the network. When receiving speech operation from the user, the apparatus body 10 inquires of the user confirmation server 52 whether the user is at a position where the operation panel of the apparatus can be viewed and whether the user is looking at the operation panel. Having received the inquiry, the user confirmation server 52 analyzes the image captured by the camera 50, confirms whether the user is at a position where the operation panel of the apparatus body 10 as the inquiry source can be viewed and whether the user is looking at the operation screen of the operation panel, and notifies the result to the apparatus body 10.

Note that the device that acquires information for determining whether the user is at a position where the operation panel of the apparatus body 10 as the inquiry source can be viewed and whether the user is looking at the operation screen of the operation panel (determination information acquirer) is not limited to the camera 50 that shoots the moving image. For example, devices may be used such as those that detect whether the user is present in the vicinity of the apparatus body 10 by an infrared human sensor, specify the location of the user from the position of a tag or a mobile terminal carried by the user, or determine whether the user is looking at the operation panel by detecting the user's line of sight.

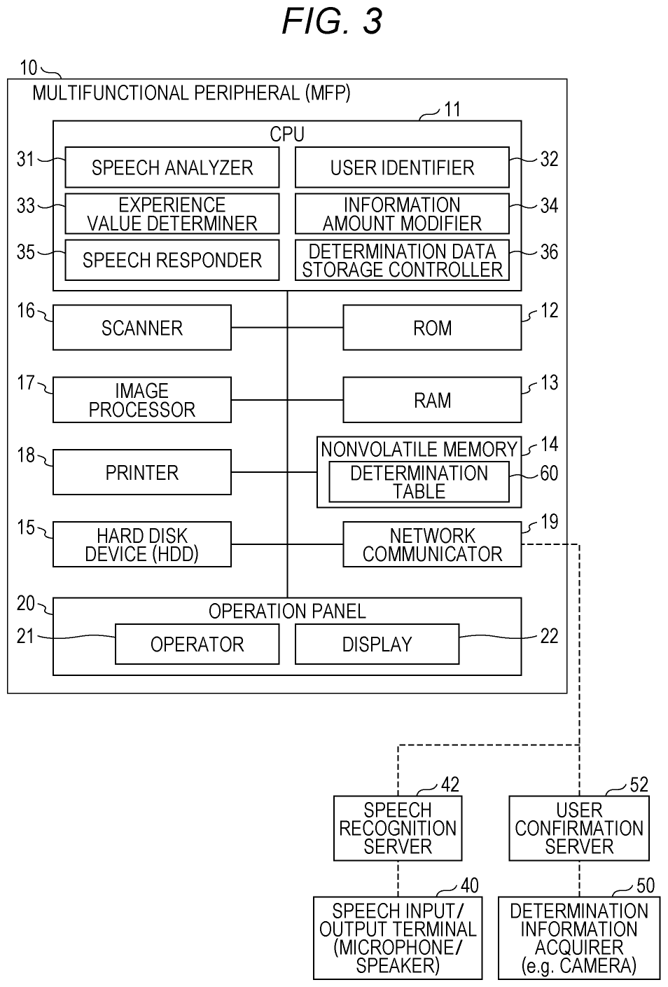

FIG. 3 is a block diagram illustrating a schematic configuration of the apparatus body 10 of the apparatus 5 illustrated in FIG. 2. The apparatus body 10 includes a central processing unit (CPU) 11 as a controller that controls the operation of the apparatus body 10 in a comprehensive manner. The CPU 11 is coupled with a read only memory (ROM) 12, a random access memory (RAM) 13, a nonvolatile memory 14, a hard disk device 15, a scanner 16, an image processor 17, a printer 18, a network communicator 19, and an operation panel 20 through a bus.

The CPU 11 is based on an operating system (OS) program, and executes middleware, application programs, and the like over the OS. Various programs are stored in the ROM 12, and each function of the apparatus body 10 is implemented by the CPU 11 executing various processes in accordance with the programs.

The RAM 13 is used as a work memory for temporarily storing various data or an image memory for storing image data when the CPU 11 executes processes on the basis of a program.

The nonvolatile memory 14 is a memory (flash memory) the stored content of which is not destroyed even when the power is turned off, and is used for storing default setting values, administrator settings, and the like. The nonvolatile memory 14 also stores a determination table 60 in which determination criteria for determining the experience value of a user regarding the use of the apparatus body 10 are registered.

The hard disk device 15 is a large-capacity nonvolatile storage device, and stores various programs and data in addition to print data and screen data of a setting screen. The hard disk device 15 further stores determination data for determining the experience value of a user.

The scanner 16 has a function of optically reading a document and acquiring image data. The scanner 16 has an automatic document feeder (ADF) for sequentially feeding out and reading a plurality of sheets of documents set on a document table. In addition, the front and back of a document can read by inverting the front and back of the document by the automatic document feeder.

The image processor 17 performs processes such as image enlargement/reduction and rotation, as well as rasterization for converting print data into image data, compression/decompression of image data, and other processes.

The printer 18 has a function of forming an image that corresponds to image data on a recording sheet. Here, the printer 18 is an engine of a so-called laser printer which includes a conveyance device of recording sheets, a photoreceptor drum, a charging device, a laser unit, a developing device, a transfer separation device, a cleaning device, and a fixing device, and forms images by an electrophotographic process. Images may be formed by another method.

The network communicator 19 has a function of communicating with various external devices and servers such as the speech recognition server 42 and the user confirmation server 52 via a network such as a LAN.

The operation panel 20 includes an operator 21 and a display 22. Various operation screens and setting screens are displayed on the display 22. The display 22 includes a liquid crystal display and its driver. The operator 21 receives various types of operation (touch operation or pressing operation) from a user. The operator 21 includes various hardware switches such as a start button and a numeric keypad, and a touch panel provided on a display plane of the display 22.

The CPU 11 controls the entire operation of the apparatus body 10, and provides, as functions related to dialogic speech operation, functions as a speech analyzer 31, a user identifier 32, an experience value determiner 33, an information amount modifier 34, a speech responder 35, and the determination data storage controller 36 and the like.

The speech analyzer 31 analyzes a text sentence received from the speech recognition server 42 and recognizes the content of speech input by the user to the speech input/output terminal 40.

The user identifier 32 has a function of specifying a user who is performing speech operation. For example, a user who is performing speech operation is identified by receiving a speech signal before text conversion from the speech recognition server 42 and performing voiceprint analysis. Note that the function of specifying the user from the voiceprint may be performed by the speech recognition server 42 or may be performed by another server by such request. The method of specifying a user who is performing speech operation is not limited to voiceprint authentication, but may be any authentication method. For example, a camera may be provided to the speech input/output terminal 40 to photograph a user to perform face authentication.

The experience value determiner 33 determines the experience value of the user who is performing the speech operation regarding the use of the apparatus.

The information amount modifier 34 modifies the setting of the information amount to be provided to the user by speech in the interaction of speech operation depending on the experience value obtained by the experience value determiner 33.

The speech responder 35 performs processes of determining the content of the speech response (the content of a speech to be output to the user) depending on the setting of the information amount by the information amount modifier 34, transmitting the data to the speech recognition server 42, and outputting corresponding speech from the speech input/output terminal 40.

The determination data storage controller 36 performs control to store various types of determination data, which are materials for determining the experience value of a user, in the hard disk device 15. Determination data includes set for each user based on a period of time elapsed from the most recent operation, the frequency of receiving the instruction operation (frequency of use), an instruction interval of received instruction operation in the past, the frequency of modifying settings in received instruction operation in the past, the frequency of use of the help function, and the frequency of interruption operation during output of a speech guidance. In the determination data, these pieces of information for each user are stored while further classified for each job type. Incidentally, operation instructions to be subjected to the determination data may be limited to instructions by speech operation, or may include both the instruction operation from the operation panel and the instruction operation by speech operation.

In a case where a period of time elapsed from the most recent operation is longer than a certain level, the experience value is evaluated as low. The higher the frequency of receiving instruction operation (frequency of use) is, the higher the experience value is evaluated. The longer an instruction interval of received instruction operation in the past is, the lower the experience value is evaluated. The higher the frequency of modifying settings in received instruction operation in the past is, the higher the experience value is evaluated. The higher the frequency of use of the help function is, the lower the experience value is evaluated. The higher the frequency of interruption operation during output of a speech guidance is, the higher the experience value is evaluated. The experience value is determined for each job type on the basis of determination data of that job type of the user.

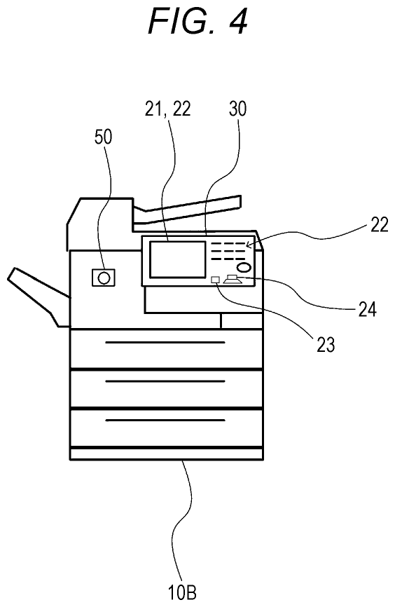

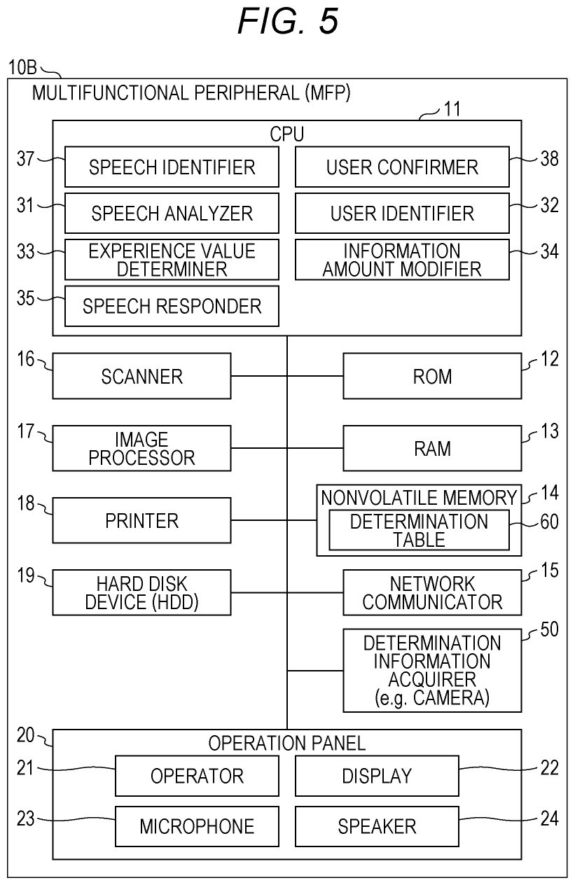

Note that an apparatus according to the present invention may be an apparatus 10B which integrates the functions of the speech input/output terminal 40, the speech recognition server 42, the camera 50, the user confirmation server 52, and the apparatus body 10 into one apparatus as illustrated in FIGS. 4 and 5. In the apparatus 10B illustrated in FIG. 4 and FIG. 5, components that perform the same function as that of the apparatus body 10 illustrated in FIG. 3 are denoted by the same symbol, and description thereof is omitted.

An operation panel 20 includes a microphone 23 and a speaker 24, and has a function as the speech input/output terminal 40. A CPU 11 is coupled with a camera 50, which is a determination information acquirer. The CPU 11 further performs functions of a speech identifier 37 that corresponds to the speech recognition server 42 and a user confirmer 38 that corresponds to the user confirmation server 52.

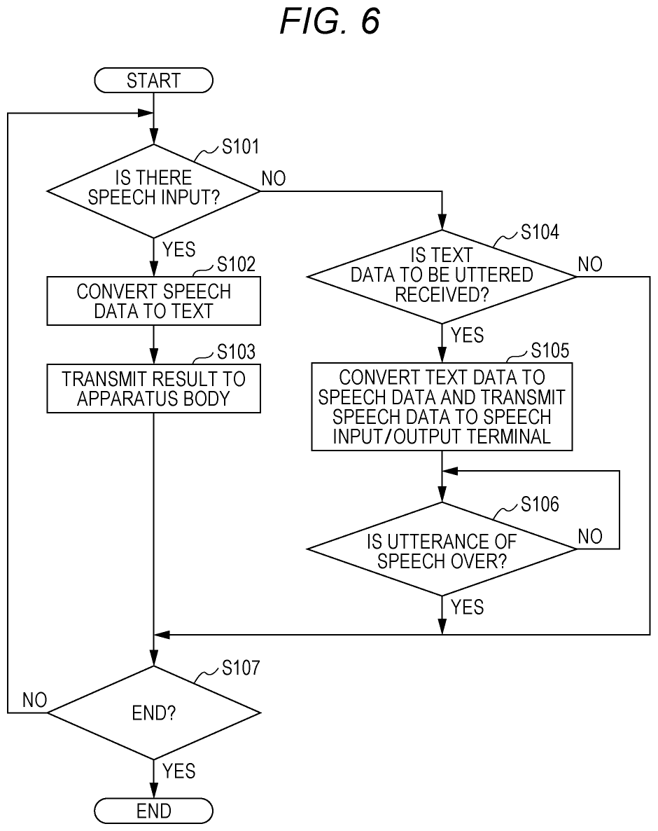

FIG. 6 is a flowchart illustrating processes performed by the speech recognition server 42. When the user speaks toward the speech input/output terminal 40 and the speech recognition server 42 receives corresponding speech data from the speech input/output terminal 40 (step S101: Yes), the speech recognition server 42 analyzes the speech data and performs text conversion (step S102). Then, the speech recognition server 42 transmits the converted text data to the apparatus body 10 (step S103) and proceeds to step S107. The apparatus body 10 that has received this data determines the speech content to respond, and transmits text data that corresponds to the speech content to the speech recognition server 42. Note that in a case where voiceprint authentication is performed by the apparatus body 10, the speech recognition server 42 transmits the speech data that is not converted to the apparatus body 10 together with the converted text data in step S103.

When the speech recognition server 42 receives the text data to be uttered from the apparatus body 10 (step S101: No, S104: Yes), the speech recognition server 42 converts the text data into speech data and transmits the speech data to the speech input/output terminal 40 (step S105), and waits for the speech utterance that corresponds to the speech data to end in the speech input/output terminal 40 (step S106: No).

As a result, the speech recognition server 42 does not accept any new speech input from the user until the speech utterance in the speech input/output terminal 40 ends. In the user interface on an interactive side, it becomes difficult to recognize the user's speech when a speech uttered by the speech input/output terminal 40 and the user's speech overlap, and thus no new speech input is accepted from the user until the speech utterance in the speech input/output terminal 40 ends. Therefore, the user needs to hold a next speech input until the speech utterance by the speech input/output terminal 40 ends.

The speech recognition server 42 determines the end of the speech utterance in the speech input/output terminal 40 from, for example, a period of time elapsed after transmission of the speech data to the speech input/output terminal 40 (preferably the period of time determined depending on the length of the speech data), or by receiving a notification of the end of the speech utterance from the speech input/output terminal 40.

When the speech utterance by the speech input/output terminal 40 ends (step S106: Yes), the speech recognition server 42 proceeds to step S107.

In step S107, it is confirmed whether the dialog between the user and the apparatus body 10 has ended. For example, it is determined that the dialog has ended when a speech instruction for starting a job is received and the instruction is transmitted to the apparatus body 10. If the dialogue has not ended (step S107: No), the speech recognition server 42 returns to step S101 and continues the processes. If the dialogue has ended (step S107: Yes), the process ends.

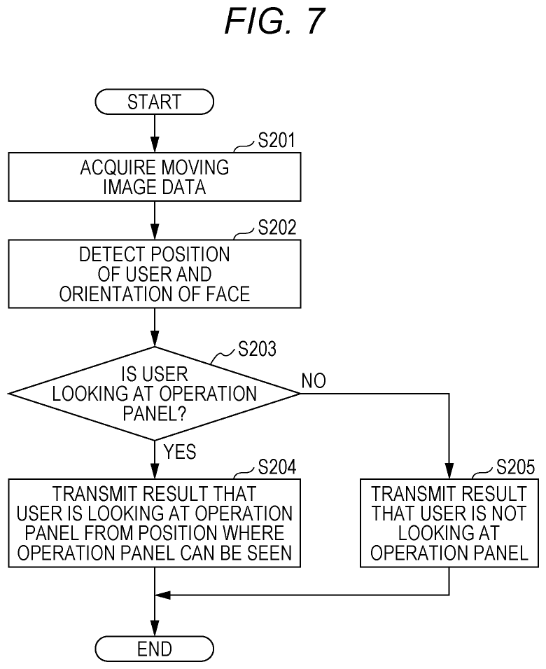

FIG. 7 is a flowchart illustrating processes performed by the user confirmation server 52. The user confirmation server 52 receives and acquires moving image data captured by the camera 50 in real time from the camera 50 (step S201), analyzes the moving image data and detects the position of the user and the orientation of the face (step S202), determines whether the user is at a position where the operation panel 20 of the apparatus body 10 can be viewed or whether the user is looking at the operation panel 20 (step S203), and transmits the determination result to the apparatus body 10 (step S204, step S205).

Here, if the user confirmation server 52 determines that the user is looking at the operation screen of the operation panel 20 from a position where the operation panel 20 of the apparatus body 10 can be viewed (step S203: Yes), the determination result indicating so is transmitted to the apparatus body 10 (step S204). If the user is not at a position where the operation panel 20 of the apparatus body 10 can be viewed or is at a position where the operation panel 20 can be viewed but is not looking at it (step S203: No), the determination result that the user is not looking at the operation panel 20 is transmitted to the apparatus body 10 (step S205).

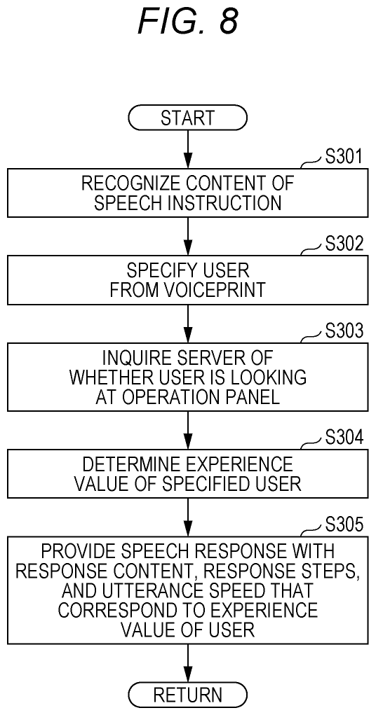

FIG. 8 is a flowchart illustrating processes performed by the apparatus body 10 regarding speech operation. Note that the apparatus body 10 displays a corresponding operation screen on the operation panel 20 when receiving speech operation.

The apparatus body 10 analyzes text data received from the speech recognition server 42 to recognize the content of the speech instruction uttered by the user (step S301). Next, the apparatus body 10 specifies the user who is performing the speech operation by voiceprint authentication or the like (step S302). The apparatus body 10 also inquires the user confirmation server 52 of whether the user who is performing the speech operation is looking at the operation panel 20 of the apparatus body 10, and receives and acquires the determination result from the user confirmation server 52 (step S303).

The apparatus body 10 derives the experience value regarding the use of the apparatus of the user specified in step S302 on the basis of the determination data that is related to the user and is stored in the hard disk device 15 and the result of the inquiry in step S303 (step S304). Note that the experience value of a user is derived without limiting job types and a speech response is performed depending on the experience value before the job type targeted by the speech operation is specified in the dialogic interaction. After the job type is specified which is targeted by the speech operation in the dialogic interaction, the experience value regarding the job type is re-derived to perform the speech response depending on the experience value.

The apparatus body 10 modifies the information amount depending on the experience value derived in step S304 to perform a speech response (step S306). Specifically, the higher the experience value is, the simpler the content of the speech guidance is, and the higher the experience value is, the more steps of interaction are omitted. In addition, in a case where the experience value is less than or equal to a certain value, the utterance speed is lowered than usual. In a speech response, the apparatus body 10 determines text data indicating the content of the speech response, and transmits the text data to the speech recognition server 42.

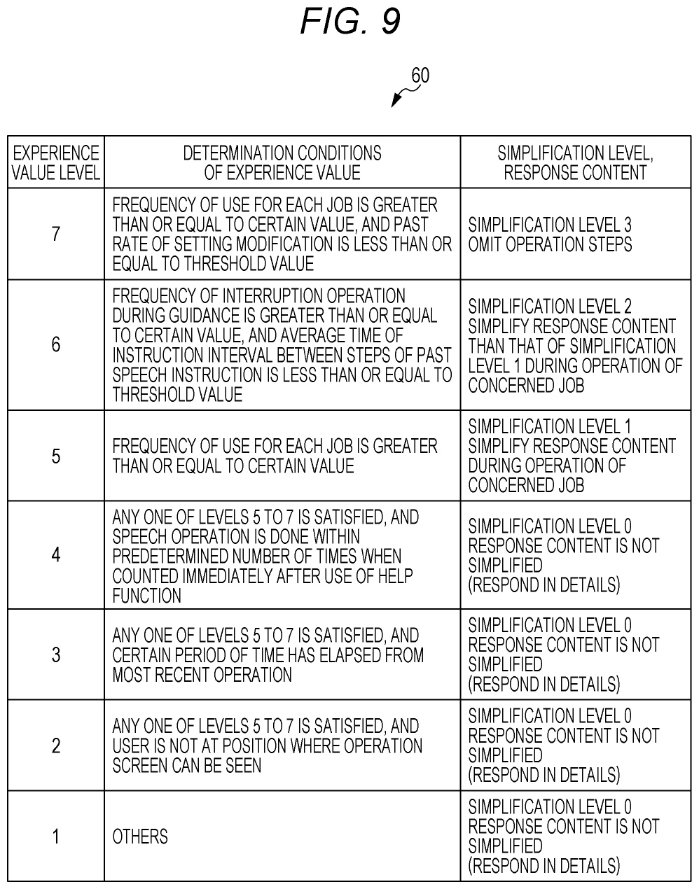

FIG. 9 is a table illustrating an example of the determination table 60 in which determination criteria for deriving an experience value in step S304 are registered. Experience values are evaluated in seven levels, from the lowest level 1 to the highest level 7.

According to the determination table 60 illustrated in FIG. 9, in a case where the frequency of use of the job type regarding the concerned user's current speech operation is greater than or equal to a certain value, and the past rate of setting modification in the settings of the job type is less than or equal to a threshold value, it is determined that the experience value level is 7. In other words, it is determined that there is no need to provide a detailed speech guidance to a user who is familiar with the concerned job and often executes the job with the default settings without modifying setting values, and the experience value level is raised.

In a case where experience value level 7 is not satisfied, the frequency of interruption operation during a speech guidance is greater than or equal to a certain value, and the average length of an instruction interval between steps in past speech operation is less than the threshold value, it is determined that the experience value level is 6. A user who performs interruption operation during a speech guidance is determined as a user who has abundant experience of use and does not require a speech guidance. In addition, it can be speculated that a user whose instruction interval is short is performing the speech operation without hesitation. Thus, the experience value level is set to 6 for such a user.

In a case where neither experience value level 7 nor 6 is satisfied, and the frequency of use of the job type regarding the current speech operation of the concerned user is greater than or equal to a certain value, it is determined that the experience value level is 5.

However, even in a case where one of experience value levels 5 to 7 is satisfied, if the speech operation is performed within a predetermined number of times immediately after using the help function, it is determined that the experience value level is 4. That is, since several times of speech operation after the use of the help function are considered to be performing settings related to the referred help function, the experience value level is lowered so that a detailed speech guidance is played.

Moreover, even in a case where one of experience value levels 5 to 7 is satisfied, if a certain period of time has elapsed since the most recent operation, it is determined that the experience value level is 3. If the apparatus has not used for a long time, it is determined that the experience value has been reduced.

Even in a case where one of experience value levels 5 to 7 is satisfied, if the user is not at a position where the operation panel 20 can be viewed, or the user is at a position where the operation screen can be viewed but is not looking at the operation panel 20, it is determined that the experience value level is 2. Since the apparatus body 10 displays a corresponding operation screen when receiving speech operation, a user who performs speech operation while looking at this operation screen can obtain information related to the operation from the operation screen. However, a user who is not at a position where the operation screen can be viewed or a user who is not looking at the operation screen cannot acquire information from the operation screen, and thus the experience value level is lowered so that the information amount of the speech response increases accordingly.

In other cases, it is determined that the experience value level is 1.

According to the determination table 60 illustrated in FIG. 9, in a case where the experience value level is 1 to 4, the simplification level is 0, and a detailed speech response is made without simplifying the response content. That is, the most detailed speech guidance is played, and the steps of dialogic interaction are not omitted.

In a case where the experience value level is 5, the simplification level is 1, and the response content is simplified to some extent. That is, a slightly simplified speech guidance is played, and the steps of dialogic interaction are not omitted. In a case where the experience value level is 6, the simplification level is 2, and the response content is further simplified than in the case of the simplification level 1. That is, a significantly simplified speech guidance is played, and the steps of dialogic interaction are not omitted. In a case where the experience value level is 7, the simplification level is 3, and the response content is further simplified than in the case of the simplification level 2. Here, a significantly simplified speech guidance is played, and some of the steps of dialogic interaction are omitted.

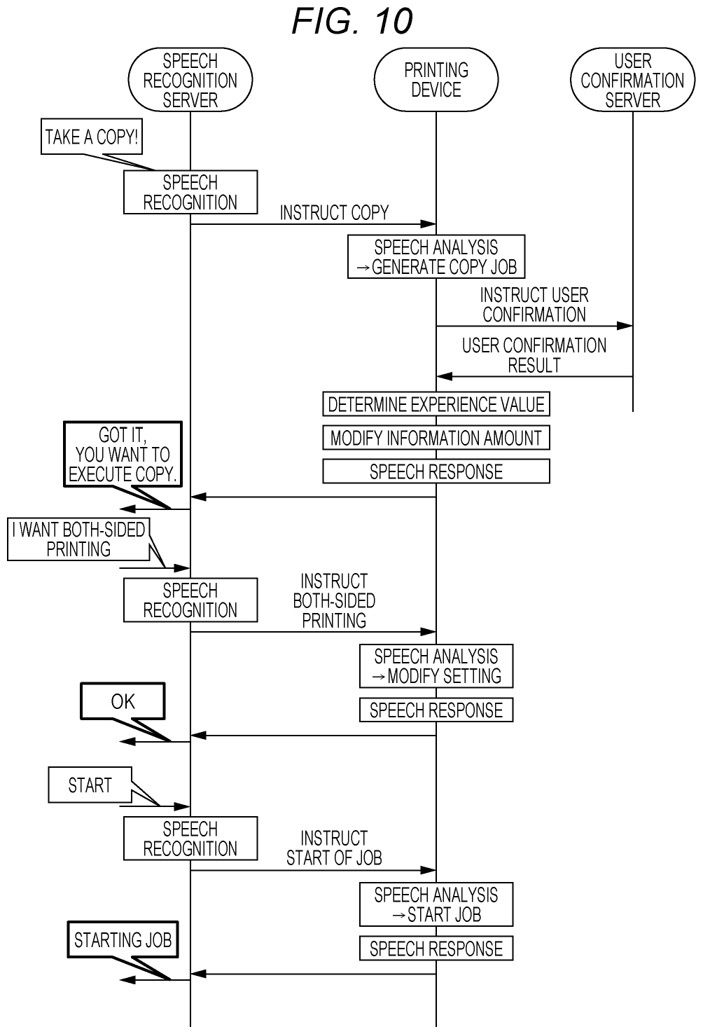

FIG. 10 illustrates an exemplary flow of speech operation for experience value level 6. When a user inputs by speech to the speech input/output terminal 40 by saying “take a copy,” the speech recognition server 42 identifies the speech and transmits text data, obtained by converting the speech thereto, to the apparatus body 10. For example, the speech recognition server 42 specifies the user on the basis of the voiceprint, and notifies the apparatus body 10 of the user name. The apparatus body 10 analyzes the received text data, recognizes the instruction content (that the instruction is to take a copy), and provisionally generates a copy job with default settings. In addition, the apparatus body 10 transmits a user confirmation instruction to the user confirmation server 52 to inquire whether the user is at a position where the operation panel 20 can be viewed or whether the user is looking at the operation panel 20.

The user confirmation server 52 acquires and analyzes a moving image from the camera 50 near the apparatus body 10 that is the source of the user confirmation instruction, determines whether the user is at a position where the operation panel 20 of the apparatus body 10 can be viewed or whether the user is looking at the operation panel 20, and returns the determination result to the apparatus body 10 that is the source of the inquiry.

The apparatus body 10 derives the experience value of the user who is performing the speech operation regarding the copy job. Here, experience value level 6 is determined. The apparatus body 10 generates text data for speech response with the information amount that corresponds to the derived experience value, transmits the text data to the speech recognition server 42, and causes the speech input/output terminal 40 to output the corresponding speech. Here, a speech response of “Got it, you want to execute copy.” is played.

Subsequently, when the user inputs by speech to the speech input/output terminal 40 by saying “I want both-sided printing,” the speech recognition server 42 identifies the speech and transmits text data, obtained by converting the speech thereto, to the apparatus body 10. The apparatus body 10 analyzes the received text data to recognize the instruction content, and modifies the settings of the copy job generated earlier to “double-sided printing”. Then, text data of the speech response is generated at the experience value level 6, and the text data is transmitted to the speech recognition server 42 to cause the speech input/output terminal 40 to output the corresponding speech. Here, a speech response of “Okay” is played.

Subsequently, when the user inputs by speech to the speech input/output terminal 40 by saying “start,” the speech recognition server 42 identifies the speech and transmits text data, obtained by converting the speech thereto, to the apparatus body 10. The apparatus body 10 analyzes the received text data, recognizes the instruction content, and starts the copy job. Then, text data of the speech response for the instruction operation of “start” is generated at experience value level 6, and the text data is transmitted to the speech recognition server 42 to cause the speech input/output terminal 40 to output the corresponding speech. Here, a speech response of “Starting the job” is played.

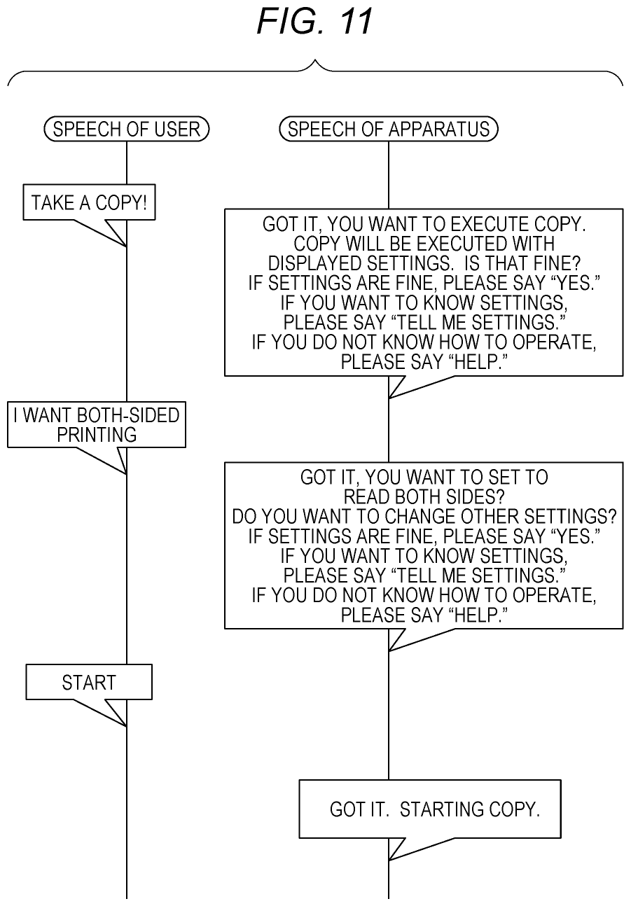

FIG. 11 is a diagram illustrating an example of interaction by speech operation for experience value levels 1 to 4. For experience value levels 1 to 4, the speech guidance in each step is performed in detail. In addition, there is no omission of steps.

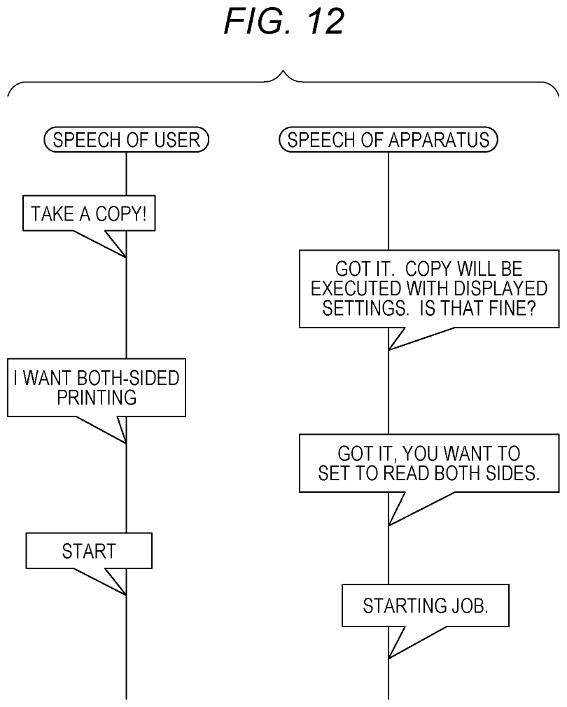

FIG. 12 is a diagram illustrating an example of interaction by speech operation for experience value level 5. For experience value level 5, the content of a speech guidance in each step is slightly simplified as compared with that is FIG. 11.

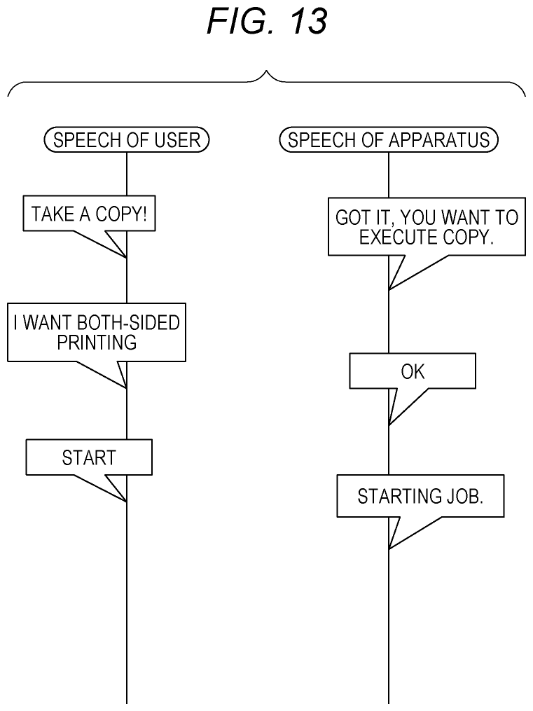

FIG. 13 is a diagram illustrating an example of interaction by speech operation for experience value level 6. For experience value level 6, the content of a speech guidance in each step is further simplified as compared with that is FIG. 12.

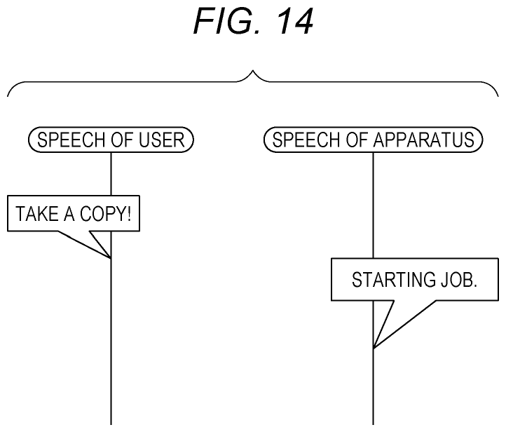

FIG. 14 is a diagram illustrating an example of interaction by speech operation for experience value level 7. For experience value level 7, dialogical steps are omitted as compared with those in FIG. 13.

In this manner, the content of a speech response and/or steps of a dialogue are simplified in multiple stages depending on the user's experience value, and the dialogic interaction is performed with details and a coverage that are suitable for each user, thereby making it possible to provide user-friendly speech operation to any user having varying experience values for the use of the apparatus.

The embodiments of the present invention have been described above with reference to the drawings; however, specific configurations are not limited to those illustrated in the embodiments, and modifications or additions within the scope not departing from the principals of the present invention are also included in the present invention.

The configuration of an apparatus according to an embodiment of the present invention is not limited to those illustrated in FIGS. 1 to 5, and may not include, for example, the user interface (the speech input/output terminal 40 and the speech recognition server 42) but is coupled thereto. It suffices to perform the functions of the speech analyzer 31, the user identifier 32, the experience value determiner 33, the information amount modifier 34, the speech responder 35, and the determination data storage controller 36 of the apparatus body 10 illustrated in FIG. 3. Furthermore, these functions may be given to a server separate from the apparatus body 10, or may be incorporated in the speech recognition server 42 or the user confirmation server 52.

In the embodiments, experience value levels are derived by adding whether the user is looking at the operation panel 20 as a determination factor; however, this may not be a determination factor. Furthermore, in the embodiments, whether the user is at a position where the operation panel 20 of the apparatus body 10 can be viewed and whether the user is looking at the operation panel 20 is used as a determination factor of the experience value level; however, whether the user is at a position where the operation panel 20 of the apparatus body 10 can be viewed may be used as a determination factor regardless of whether the user is actually looking at the operation panel 20.

In addition, in a case where a user near the operation panel 20 performs speech operation without looking at the operation panel 20, it can be speculated that the user is experienced enough to perform speech operation without looking at the operation screen without any problem, the experience value level may be increased as compared with a case where a user near the operation panel 20 performs speech operation while looking at the operation panel 20.

In the embodiments, a corresponding operation screen is displayed on operation panel 20 when speech operation is received; however, speech operation may be received without displaying an operation screen.

An apparatus according to the present invention is not limited to an MFP described in the embodiments, and may be any apparatus that performs dialogic speech operation.

Although embodiments of the present invention have been described and illustrated in detail, the disclosed embodiments are made for purposes of illustration and example only and not limitation. The scope of the present invention should be interpreted by terms of the appended claims.

What is claimed is:

1. An apparatus that receives an instruction from a user by speech by dialogic interaction, the apparatus comprising:
a hardware processor that:
determines an experience value of the user regarding use of the apparatus; and
modifies an information amount to be provided to the user by speech in the dialogic interaction depending on the user's experience value determined by the hardware processor.

2. The apparatus according to claim 1,
wherein the hardware processor determines the experience value using, as a determination factor, at least one of a period of time elapsed from a most recent instruction received from the user, frequency of instructions received from the user, an instruction interval of past instructions received from the user, frequency of modifying setting in past instructions received from the user, frequency of use of a help function by the user, or frequency of interruption operation performed by the user during output of a speech guidance.

3. The apparatus according to claim 1,
wherein the hardware processor modifies an utterance speed of a speech provided to the user depending on the experience value of the user.

4. The apparatus according to claim 1,
wherein the hardware processor omits a step of the dialogic interaction depending on the experience value of the user.

5. The apparatus according to claim 1,
wherein the hardware processor reduces more of the information amount provided to the user by speech as the experience value is higher.

6. The apparatus according to claim 5,
wherein the hardware processor sets the experience value to a predetermined low level regardless of other determination factors in a case where a period of time elapsed from a most recent instruction received from the user by speech by dialogic interaction is longer than or equal to a certain level.

7. The apparatus according to claim 5,
wherein the hardware processor sets the experience value to a predetermined high level regardless of other determination factors in a case where the user performs interruption operation during output of a speech guidance for more than a certain number of times continuously.

8. The apparatus according to claim 5, further comprising:
an operation panel that displays an operation screen that corresponds to speech operation,
wherein the hardware processor acquires information that allows for determination whether the user is at a position where the operation screen can be viewed, and
the hardware processor sets the experience value to a predetermined low level regardless of other determination factors when the user is at a position where the operation screen cannot be viewed.

9. The apparatus according to claim 1,
wherein the hardware processor determines the experience value for each job type.

10. The apparatus according to claim 1,
wherein the apparatus is used while coupled to a user interface that does not accept speech input from a user during output of a speech.
